(19) United States
(12) Patent Application Publication
(10) Pub. No.: US 2013/0262034 A1
(43) Pub. Date: Oct. 3, 2013

(54) HAND HYGIENE TRACKING SYSTEM

(71) Applicants: Mert Iseri, Evanston, IL (US); Yuri Malina, Evanston, IL (US); Jori Hardman, Chicago, IL (US)

(72) Inventors: Mert Iseri, Evanston, IL (US); Yuri Malina, Evanston, IL (US); Jori Hardman, Chicago, IL (US)

(21) Appl. No.: 13/769,161

(22) Filed: Feb. 15, 2013

Related U.S. Application Data
(60) Provisional application No. 61/619,815, filed on Apr. 3, 2012.

(51) Int. Cl. G06F 17/00

(52) U.S. Cl. CPC G06F 17/00
USPC 702/187

(57) ABSTRACT

In accordance with some embodiments of the present disclosure, a method may comprise collecting at least one instance of user-location information, wherein each instance of the user-location information includes a user identifier, a location identifier, and a user time, and collecting at least one instance of dispense-location information, wherein each instance of the dispense-location information includes the user identifier, the location identifier, and a sanitizer dispense time.

### RELATED APPLICATION

This application claims the benefit of U.S. Provisional patent application Ser. No. 61/619,815 filed Apr. 3, 2012, the contents of which is incorporated by reference in its entirety.

### TECHNICAL FIELD

The present disclosure relates generally to public health technology and more particularly to a system for tracking the hand hygiene of individuals.

### BACKGROUND

Hand hygiene is critical to preventing the spread of infection, germs, and/or disease. The prevention of such spreading is especially critical in the hospital environment. Many hospitals and other health care facilities have implemented hand sanitization protocols under which hospital and other health care employees are required to wash or sanitize their hands at regular intervals or during certain actions such as entering a patient's room. In order to maintain compliance with such protocols, hospital employees and other health care workers must have convenient access to hand sanitizers. Moreover, to ensure a sanitary environment, hospitals and other health care facilities may wish to track hand hygiene compliance.

### SUMMARY

In accordance with teachings of the present disclosure, disadvantages and problems associated with hand sanitizer dispensers have been substantially reduced or eliminated. In one embodiment of the present disclosure, a method is closed. In accordance with the present disclosure, a method may comprise collecting at least one instance of user-location information, wherein each instance of the user-location information includes a user identifier, a location identifier, and a user time, and collecting at least one instance of dispense-location information, wherein each instance of the dispense-location information includes the user identifier, the location identifier, and a sanitizer dispense time.

In another embodiment of the present disclosure, another method is disclosed. The method may comprise determining a location identifier, receiving the user identifier from an electronic module at a first time, transmitting the user identifier and the location identifier to a network server after receiving the user identifier from the electronic module at the first time, receiving the user identifier and a dispense-information packet from the electronic module at a second time, and transmitting the user identifier, the location identifier, and the dispense-information packet to the network server after receiving the user identifier and the dispense-information packet from the electronic module at the second time.

The object and advantages of the invention will be realized and attained by means of at least the features, elements, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 illustrates an exploded view of certain components of a hand sanitizer dispenser, in accordance with certain embodiments of the present disclosure;

FIG. 2A illustrates a block diagram of a hand hygiene tracking system, in accordance with certain embodiments of the present disclosure;

FIG. 2B illustrates a block diagram of a hand hygiene tracking system, in accordance with certain embodiments of the present disclosure;

FIG. 3 illustrates a block diagram of a hand hygiene tracking system, in accordance with certain embodiments of the present disclosure;

FIG. 4 illustrates a block diagram of a hand hygiene tracking system, in accordance with certain embodiments of the present disclosure;

FIG. 5 illustrates a flow chart depicting method for communicating hand hygiene information, in accordance with certain embodiments of the present disclosure; and

FIGS. 6A and 6B illustrate a flow chart depicting method for communicating hand hygiene information, in accordance with certain embodiments of the present disclosure.

### DETAILED DESCRIPTION

In accordance with the teachings of the present disclosure, a method and system for tracking hand hygiene is provided.

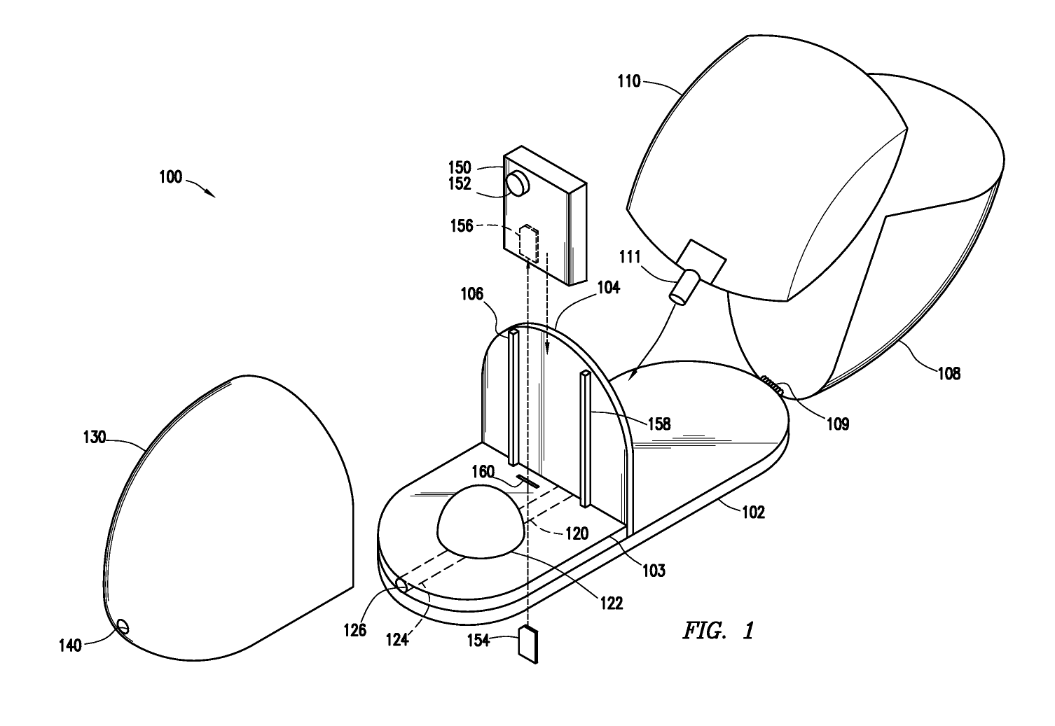

FIG. 1 illustrates an exploded view of certain components of hand sanitizer dispenser 100, in accordance with certain embodiments of the present disclosure. Dispenser 100 may include a dispenser base 102, a pump housing 103, a sanitizer encasement 108, a hinge 109, a replaceable pouch 110 of hand sanitizer, a pump intake channel 120, a diaphragm pump 122, a pump outlet channel 124, a dispenser outlet 126, a push plate 130, an electronic module 150, and rails 158.

In some embodiments, sanitizer encasement 108 may rotate about hinge 109, which may be coupled to dispenser base 102. Accordingly, sanitizer encasement 108 may be opened to allow a replaceable pouch 110 of hand sanitizer to be coupled to dispenser 100. Dispenser 100 may include a dispenser intake (not expressly shown) that may be coupled to pouch 110's nozzle 111 in order to allow sanitizer to flow from pouch 110 into pump intake channel 120.

Pump intake channel 120 may be located within pump housing 103. In some embodiments, a one-way intake valve (not expressly shown) may be located between pump intake channel 120 and diaphragm pump 122. The one-way intake valve may include any suitable type of one-way valve, for example, a flap valve, a duck-billed valve, or a check valve. Diaphragm pump 122 may be in fluid communication with pump outlet channel 124.

For the purposes of the present disclosure, one feature may be in “fluid communication” with another feature if a fluid or gel may be able to flow, or be allowed to flow, from the one feature to the other feature. In some embodiments, a one-way outlet valve (not expressly shown) may be located at the end of pump outlet channel 124, e.g., at or near the location of dispenser outlet 126. The one-way outlet valve may include any suitable type of one-way valve, for example, a flap valve, a duck-billed valve, or a check valve.

In some embodiments, push plate 130 may be coupled either directly or indirectly to dispenser base 102 via a spring-loaded coupling. Moreover, push plate 130 may be configured to actuate diaphragm pump 122 when push plate 130 is pressed. For example, push plate 130 may include a pump actuator (not expressly shown) that may extend from the inner surface of push plate 130. The pump actuator may be configured to make contact with and to press down upon diaphragm pump 122 when push plate 130 is pressed. The outer surface of push plate 130 may be configured in a rounded manner and may be sized to fit in the palm of a user's hand. Accordingly, push plate 130 may allow a user to ergonomically squeeze the lower portion of dispenser 100 with the palm of one hand.

Diaphragm pump 122 may include a dome-like structure that may partially encircle a pump chamber. Diaphragm pump 122 may include a flexible material that may collapse when pressed and recoil to its natural dome-like shape when released. When a user presses push plate 130, the pump actuator may press diaphragm pump 122, and the fluid pressure inside of the pump chamber may force sanitizer out of the pump chamber through pump outlet channel 124. At this time, the one-way outlet valve may open and allow sanitizer to flow out of the dispenser outlet 126. Moreover, when push plate 130 is pressed downward, dispenser opening 140 may align with dispenser outlet 126, allowing a dose of sanitizer to be dispensed to a user.

After push plate 130 is released, and the downward force on diaphragm pump 122 is released, diaphragm pump 122 may return to its resting dome-like shape. When diaphragm pump 122 recoils to its resting dome-like shape, it may create a vacuum force within its pump chamber. The vacuum pressure inside the pump chamber may pull sanitizer from pouch 210 into the pump chamber via pump intake channel 120 and the one-way intake valve. Accordingly, diaphragm pump 122 may be refilled with sanitizer and ready for the next dispensing action.

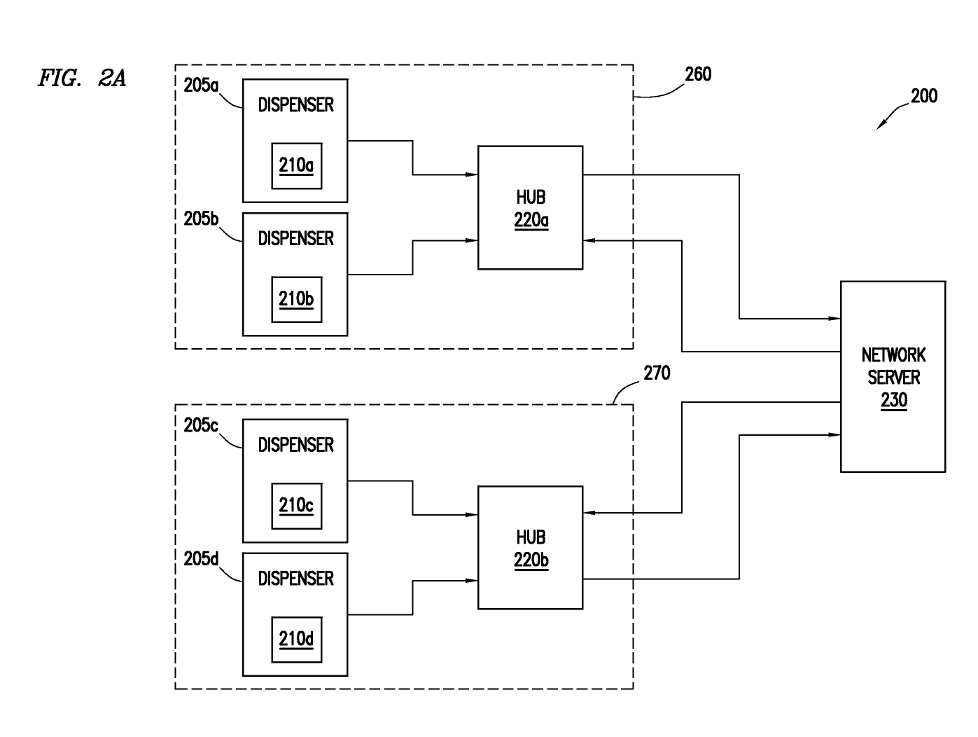

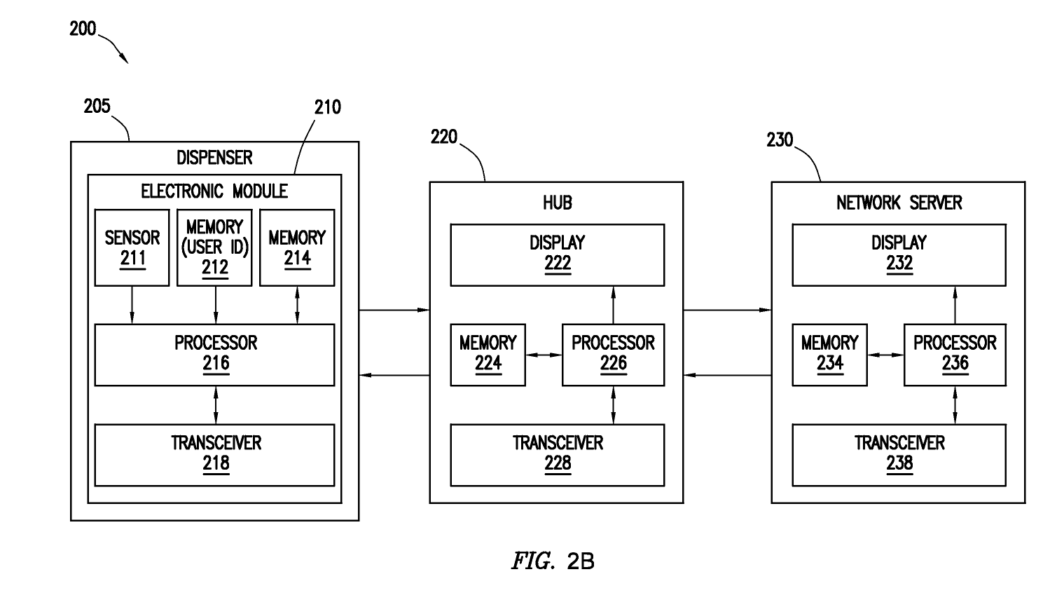

Electronic module 150 may be configured to record and transmit information regarding dispensing actions. In some embodiments, electronic module 150 may include any suitable type of switch that may be used to sense a dispensing action. Electronic module 150 may include, for example, a magnetically actuated hall sensor or a physically actuated switch. In some embodiments, contact switch 152 may be used to sense a dispensing action. Dispenser 100 may include a switch actuator (not expressly shown) that may be coupled to and/or extend from the inner surface of push plate 130, and may engage contact switch 152. Accordingly, contact switch 152 may sense the dispensing action. Components within electronic module 150 that are used to record the occurrence of a dispensing action and to transmit such data to a hand hygiene tracking network are described below with reference to FIG. 2B.

In some embodiments, electronic module 150 may include a unique user identifier to distinguish between different users that may use one or more units of dispenser 100. In some embodiments, a user identifier may be stored in a non-volatile memory permanently located within electronic module 150. For such embodiments, each hospital employee may be assigned an electronic module 150 and may be identified by the user identifier contained within their assigned electronic module 150. Electronic module 150 may be configured to be interchangeably inserted into and out of different dispenser 100 units. Accordingly, the user identifier may be user-specific rather than dispenser-specific. In some embodiments, push plate 130 may be configured to be easily detached from and re-attached to dispenser 100 so that a user may easily remove their electronic module 150 from one dispenser 100 and/or insert their electronic module 150 into another dispenser 100. To aid such functionality, dispenser 100 may include rails 158, which may be configured to allow electronic module 150 to be easily slid into place and secured along dispenser wall 104.

In some embodiments, electronic module 150 may be configured to be placed within dispenser 100 on a long-term basis. For such embodiments, each hospital employee may be assigned a transferable memory card 154 that may include a user identifier stored in non-volatile memory. Accordingly, in some embodiments, the user identifier may be user-specific rather than dispenser-specific. Memory card 154 may include any suitable memory device. For example, some embodiments of memory card 154 may include a secure-digital card (“SD-card”), a micro SD-card, or a Universal Serial Bus (“USB”)-drive. To accommodate the use of memory card 154, electronic module 150 may include a memory receptacle 156, in which memory card 154 may be placed in order to be brought into electrical and/or communicative coupling with other electrical components within electronic module 150. Such other electrical components within electronic module 150 are described in further detail below with respect to FIG. 2B. Moreover, to accommodate the placement of memory card 154 into memory receptacle 156, dispenser 100 may include opening 160, which may extend through the bottom of dispenser base 102 and/or pump housing 103. Opening 160 may align with memory receptacle 156 when electronic module 150 is placed in dispenser 100 along dispenser wall 104. Accordingly, memory card 154 may be inserted through the bottom of dispenser 100's opening 160, and into electronic module 150's memory receptacle 156.

Such embodiments may provide flexibility to the way that individual units of dispenser 100 are used. For example, different hospital employees, including those working at different times, may share a common pool of generic dispenser 100 units, and may individually participate in a hand hygiene monitoring program by simply inserting their respective electronic modules 150 and/or memory cards 154 into dispenser 100 without the need for a dispenser-specific identifier. Moreover, if a dispenser 100 malfunctions, a hospital employee may simply insert their assigned electronic module 150 or memory card 154 into another dispenser 100 to continue participating in the hand hygiene monitoring program.

FIG. 2A illustrates a block diagram of a hand hygiene tracking system 200, in accordance with certain embodiments of the present disclosure. Tracking system 200 may include a plurality of hand sanitizer dispensers 205, which may each include an electronic module 210. Also, tracking system 200 may include a plurality of hubs 220 and a network server 230.

Hand hygiene tracking system 200 may be implemented in any suitable environment in which hand hygiene may be critical to preventing the spread of infection, germs, and/or disease. For example, tracking system 200 may be implemented in medical environments such as hospitals, doctors' offices, or urgent care centers. Moreover, tracking system 200 may be implemented in non-medical environments such as restaurants and other food service facilities.

In a hospital environment, for example, personal hand-sanitizer dispensers 205a-d may be carried and used by users such as doctors and nurses. As described in greater detail below, each dispenser 205 may include an electronic module 210 which may be configured to communicate with different hubs 220 that may be installed in different locations throughout the hospital. For example, users carrying dispensers 205a and 205b enter into a first hospital room 260, electronic modules 210a and 210b may communicate with hub 220a. Likewise, when users carrying dispensers 205c and 205d enter into a second hospital room 270, electronic modules 210c and 210d may communicate with hub 220b. Each hub 220 may be configured to add location information to any information received from an electronic module 210, and may transmit that location information along with any user identifier and/or dispense indicator received from electronic module 210 to network server 230. For example, electronic module 210 may be configured to periodically transmit a user identifier to a location-specific hub 220, which may allow network server 230 to track the location of electronic module 210 and/or the user over time. Moreover, electronic module 210 may be configured to transmit a dispense indicator along with the periodic transmission of the user identifier to the location-specific hub 220 when a dispensing action has occurred in the previous time period. Accordingly, network server 230 may track the location of a user over time as well as the time and location of any dispensing actions (i.e., instances of a user sanitizing their hands) for that user.

Dispenser 205 may be implemented by any suitable sanitizer dispenser that may be used in conjunction with electronic module 210. For example, in some embodiments, dispenser 205 may be implemented by dispenser 100 of FIG. 1.

FIG. 2B illustrates a block diagram of a hand hygiene tracking system 200, in accordance with certain embodiments of the present disclosure. In some embodiments, electronic module 210 may include a memory 214, a processor 216, and a transceiver 218. In another embodiment, electronic module 210 may include a sensor 211. In yet another embodiment, electronic module 210 may include a user identifier memory 212. Electronic module 210 may be configured to communicate with one or more hubs 220 and/or network server 230.

Processor 216 may comprise, for example, a microprocessor, microcontroller, digital signal processor (DSP), application specific integrated circuit (ASIC), or any other digital or analog circuitry configured to interpret and/or execute program instructions and/or process data. In some embodiments, processor 216 may interpret and/or execute program instructions and/or process data stored in memory 214. Memory 214 may be configured in part or whole as application memory, system memory, or both. Memory 214 may include any system, device, or apparatus configured to hold and/or house one or more memory modules. Each memory module may include any system, device or apparatus configured to retain program instructions and/or data for a period of time (e.g., computer-readable storage media). Instructions, logic, or data for configuring the operation of electronic module 210, for example configurations of components such as transceiver 218, may reside in memory 214 for execution by processor 216.

Electronic module 210 may include user identifier memory 212, which may store a user identifier. In some embodiments, user identifier memory 212 may include a non-volatile memory permanently located within electronic module 210. In some embodiments, user identifier memory 212 may include an interchangeable non-volatile memory such as memory card 154 described above with reference to FIG. 1. Processor 216 may be configured to read the user identifier memory and may instruct transceiver 218 to transmit the user identifier to hub 220 at specified times (e.g., at a regular interval of 15 seconds).

In some embodiments, electronic module 210 may be configured to periodically transmit the user identifier to a location-specific hub 220. For example, if a user carries their dispenser 205, which may include electronic module 210, into a hospital room, electronic module 210 may communicate with that room's hub 220. Time information may be added to the periodically transmitted user identifier in any suitable manner. In some embodiments, electronic module 210 may include a clock that tracks the time of day. In such embodiments, electronic module 210 may transmit time information to hub 220 along with the user identifier for each periodic transmission of the user identifier. In some embodiments, however, the task of adding time information to each periodic transmission of the user identifier may be allocated to hub 220 in order to reduce the amount of circuitry needed in electronic module 210 and to reduce the amount of data that is transmitted from electronic module 210. For example, hub 220 may include a clock and may record the time at which the user identifier was received from electronic module 210. Hub 220 may then transmit the user identifier, hub 220's location information, and the time information to network server 230. This time information may be used by network server 230 along with the location identifier to track the location of a user over a period of time, and accordingly may be referred to herein as “user-time information.”

In some embodiments, the task of adding user-time information to periodic transmissions of the user identifier may be allocated to network server 230. For example, network server 230 may include a clock and may record the time at which the user identifier and the location information was received by network server 230 from hub 220. Because hub 220 may transmit the user identifier and hub 220's location information to network server 230 shortly after receiving the user identifier from electronic module 210, the user-time information added at network server 230 may accurately represent the time at which electronic module 210 transmitted the user identifier to hub 220. Accordingly, in any of the above described embodiments, tracking system 200 may track the location of electronic module 210 over time as a user carries dispenser 205 and/or electronic module 210 to different locations equipped with different units of location-specific hub 220.

Sensor 211 may be configured to sense when a dispensing action has occurred. In some embodiments, sensor 211 may include, for example, a magnetically actuated hall sensor or a contact switch, which, similar to contact switch 152 described above with reference to FIG. 1, may sense when a user presses down on push plate 130 to engage diaphragm pump 122. In some embodiments, sensor 211 may be configured to sense any other force or motion that may occur during a dispensing action, for example, the activation of a sanitizer pump and/or the flow of sanitizer out of a dispenser outlet.

In response to sensing a dispensing action, sensor 211 may communicate such a sensing, and processor 216 may record a dispense indicator. Processor 216 may record the dispense indicator in memory 214. In some embodiments, transceiver 218 may transmit the dispense indicator with the user identifier at the time of the next periodic transmission of the user identifier to a location-specific hub 220.

Dispense-time information may be calculated by any suitable means. As described above, the electronic module 210 may include a clock that tracks the time of day. In such embodiments, electronic module 210 may add dispense-time information to the dispense indicator. Accordingly, during the next periodic transmission of the user identifier after a dispensing action, electronic module 210 may transmit the user identifier, user-time information, the dispense indicator, and dispense-time information to hub 220. Hub 220 may then relay that information along with hub 220's location information to network server 230.

As described above, in some embodiments, the task of adding the user-time information may be allocated to hub 220 or network server 230 in order to simplify electronic module 210's circuitry and to minimize the amount of data that is transmitted from electronic module 210. In such embodiments, rather than having a clock that tracks the time of day, electronic module 210 may include a timer that may count the time between successful periodic transmissions of the user identifier. For example, in some embodiments, transceiver 218 may be programmed to periodically transmit the user identifier every fifteen seconds. If hub 220 successfully receives the transmission of the user identifier, hub 220 may confirm the receipt of the transmission by sending what is known in the art as an “acknowledgement packet” to the electronic module 210. In some embodiments, the acknowledgement packet may be a binary signal indicating receipt. In some embodiments, the acknowledgement packet may identify which hub 220 received the transmission. After electronic module 210 receives an acknowledgement packet, electronic module 210's timer may reset and may begin counting from zero. If a dispensing action occurs ten seconds after the acknowledgement packet was received, processor 216 may record a time stamp of ten seconds to memory 214 along with the dispense indicator. In some embodiments, the dispense indicator may include the time stamp. Moreover, in some embodiments, the time stamp itself may be the dispense indicator. A second periodic transmission of the user identifier may occur, for example, fifteen seconds after a first periodic transmission of the user identifier. During this second periodic transmission of the user identifier, transceiver 218 may transmit the dispense indicator and/or time stamp along with the user identifier to hub 220. If electronic module 210 receives an acknowledgment that this second periodic transmission was received by hub 220, electronic module 210 may delete the dispense indicator and/or time stamp and restart its timer.

In some situations, electronic module 210 may not receive an acknowledgement packet from hub 220 after a periodic transmission of the user identifier. For example, a user may carry their electronic module 210 outside of the range of any hub 220 located in a hospital. In such situations, the timer of electronic module 210 may continue running, and any recorded dispense indicators and/or time stamps, may continue to be stored by electronic module 210 until the next successful periodic transmission of the user identifier (e.g., the next periodic transmission for which an acknowledgement packet is received). For example, if a first periodic transmission of the user identifier is acknowledged, the timer may be reset and any dispense indicators and/or time stamps may be discarded. If a dispensing action is sensed ten seconds after the first periodic transmission occurs, a time stamp of ten seconds may be recorded. A second periodic transmission of the user identifier may occur fifteen seconds after the first periodic transmission. Accordingly, a time period of fifteen seconds and the time stamp of ten seconds may be transmitted with the second periodic transmission of the user identifier. If no acknowledgment is received (e.g., because electronic module 210 is outside the range of any hub 220), the timer may continue running and electronic module 210 may continue to store the time stamp of ten seconds. A third periodic transmission of the user identifier may then occur thirty seconds after the first periodic transmission. Accordingly, a time period of thirty seconds and the time stamp of ten seconds may be transmitted with the third periodic transmission of the user identifier. If an acknowledgment is received (e.g., because electronic module 210 has come back into range of hub 220), electronic module 210 may restart its timer and discard the successfully transmitted time stamp.

In some embodiments, the task of calculating a dispense time based on the time period and the dispense indicator and/or time stamp from electronic module 210, may be allocated to hub 220 or network server 230. For example, hub 220 may include a clock that tracks the time of day. Hub 220 may calculate dispense-time information based on the clock and the time period and the dispense indicator and/or time stamp received from electronic module 210. Hub 220 may calculate the dispense-time information by subtracting the time period from the time at which hub 220 received the dispense indicator and/or time stamp from electronic module 210, and then adding the time of the time stamp. For example, hub 220 may receive a time period of fifteen seconds and dispense indicator with a time stamp of ten seconds at 11:40:30 AM. Hub 220 may then calculate a dispense-time of 11:40:25 AM. Hub 220 may then transmit the user identifier, hub 220's location information, the dispense indicator and/or time stamp, and the dispense-time information to network server 230. In some embodiments, the calculated dispense-time information may itself indicate that a dispensing action occurred, and accordingly the dispense indicator and/or time stamp may be omitted from the transmission from hub 220 to network server 230.

In some embodiments, the dispense-time information may be calculated at network server 230. In such embodiments, hub 220 may relay the time period and dispense indicator and/or time stamp received from electronic module 210 to network server 230 along with the user identifier and location information shortly after receiving the dispense indicator and/or time stamp from electronic module 210. Network server 230 may then calculate the dispense-time information based on network server 230's clock, the time period, and the dispense indicator and/or time stamp received from electronic module 210 via hub 220. Network server 230 may calculate the dispense-time information by subtracting the time period from the time at which network server 230 received the dispense indicator and/or time stamp from hub 220, and then adding the time of the time stamp. For example, network server 230 may receive a time period of fifteen seconds and dispense indicator with a time stamp of ten seconds at 11:40:30 AM. Network server 230 may then calculate a dispense-time of 11:40:25 AM.

In some embodiments, transceiver 218 of electronic module 210 may be configured to transmit and/or receive information on any suitable wired or wireless communications platform. For example, transceiver 218 may be configured to communicate with hub 220 via Bluetooth, Wi-Fi, a micro-power wireless communication protocol such as the Adaptive Network Topology (“ANT”) protocol, or any other suitable wireless communication protocol. In some embodiments, electronic module 210 may be powered by one or more batteries that may be included within electronic module 210. For example, electronic module 210 may include one or more button cell batteries, coin cell batteries, lithium cell batteries, or any other suitable type of batteries.

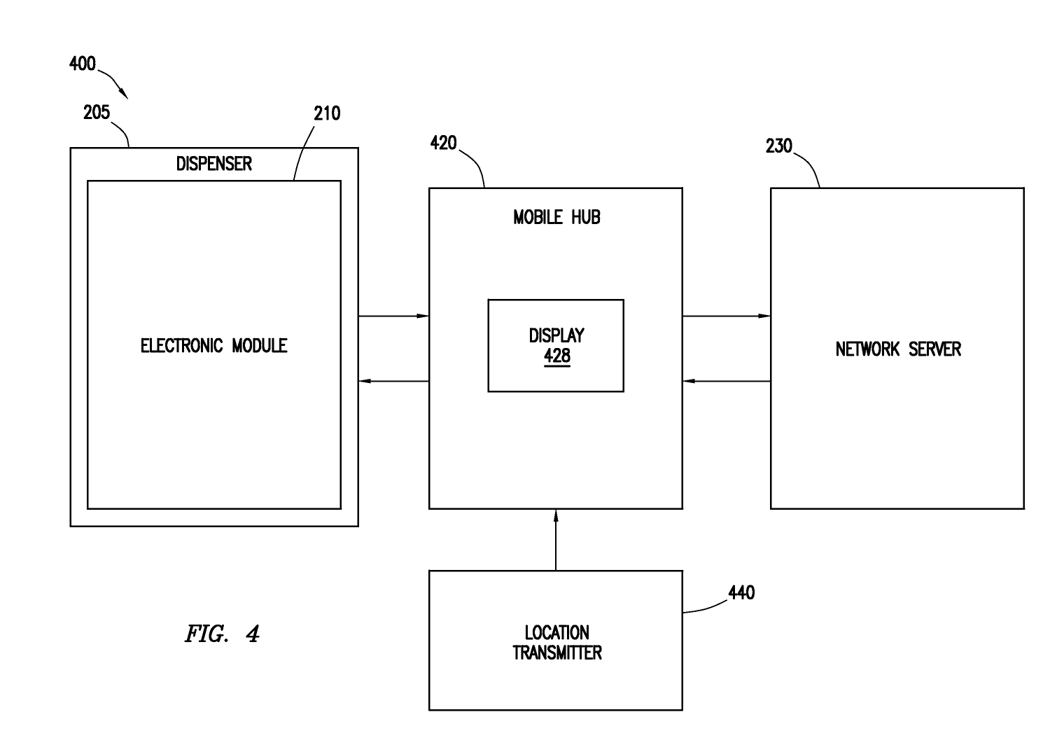

To conserve battery power, electronic module 210 may, in some embodiments, be configured with a minimal amount of circuitry to perform the above-described functions. For example, as described above, electronic module 210 may be configured with a timer that may count the time between the periodic transmissions of the user identifier, but may otherwise omit a clock that tracks the time of day, in order to reduce the amount of circuitry included in electronic module 210 and to reduce the amount of data transmitted from electronic module 210. Moreover, in some embodiments, memory 214 may include a limited amount of memory to which processor 216 may record a dispense indicator and/or time stamp. In some embodiments, after one dispense indicator is recorded and successfully transmitted, processor 216 may discard that dispense indicator by either disregarding it or overwriting that dispense indicator with a subsequent dispense indicator. For some embodiments, such a minimalist design may allow electronic module 210 to conserve energy and thus operate with the same battery for a long period of time. In some embodiments, electronic module 210 may transmit any suitable number of dispense indicators and/or time stamps. For example, in some embodiments, memory 214 may include enough memory to include fourteen dispense indicators (including fourteen time stamps). In such embodiments, electronic module 210 may also be configured to receive and store into memory 214 location information for each of the dispense indicators as described in greater detail below with reference to FIG. 4. Over a period of time, processor 216 may record fourteen dispense indicators to memory 214 corresponding to fourteen different dispensing actions that may occur between successful transmissions to a location-specific hub 220. In some cases, multiple dispensing actions may occur in between normal periodic transmissions of the user identifier. In other cases, multiple dispense indicators and/or time stamps may be recorded while electronic module 210 is out of the wireless communication range of any hub 220. In response to the next successful periodic transmission of the user identifier when electronic module 210 is in range of a location-specific hub 220, for example, transceiver 218 may transmit all fourteen dispense indicators and/or time stamps to hub 220, and processor 216 may then discard the multiple dispense indicators and/or time stamps stored in memory 214.

In some embodiments, a micro-power wireless communication protocol such as the ANT protocol may be utilized by components within electronic module 210, e.g., processor 216 and/or transceiver 218, in order to optimize battery life. Micro-power transceivers (e.g., ANT transceivers) may conserve power by operating in a low-power “sleep” mode between data transmissions. In some embodiments, transceiver 218 may be programmed to “wake up” to transmit data at a programmed time interval and/or at every dispensing action, and otherwise operate in a sleep mode between transmissions. For example, in some embodiments, transceiver 218 may be programmed to wake up every fifteen seconds to transmit a user identifier and any recorded dispense indicators to the nearest room-specific hub 220 in a hospital network. Accordingly, the tracking system 200 may track the location of a user as that user travels, for example, to different hospital rooms throughout a work shift. Tracking system 200 may also track the times and the locations at which a user sanitized their hands throughout a work shift. The handling of the dispense indicator, user identifier, and location identifier by hub 220 and network server 230 is described in greater detail below.

The time interval at which transceiver 218 may be programmed to wake up in order to periodically transmit a user identifier may depend on a trade-off between power consumption and the desired resolution for tracking a user's location. Shorter time intervals may provide greater resolution with respect to where a hospital employee carrying dispenser 205 traveled and when they traveled there, but may consume more power over a period of time due to the more frequent transmissions. On the other hand, longer time intervals may conserve power but may not provide the necessary resolution. In some applications with relaxed power consumption requirements and relaxed resolution requirements, transceiver 218's wake-up time interval may be programmed to be anywhere from less than approximately one second to greater than approximately one minute. For other applications that require conserving energy as well as providing a enough resolution to track the room-to-room movement of a user, transceiver 218's wake-up interval may correspond with the amount of time that it may take a hospital employee to walk at an average pace from one location of interest (e.g., a first patient room) to another location of interest (e.g., a second patient room). For such applications, transceiver 218's wake-up time interval may be programmed to be from approximately five seconds to approximately twenty-five seconds. In some embodiment, transceiver 218's wake-up time interval may be approximately fifteen seconds.

Hub 220 may include a display 222, a memory 224, a processor 226, and a transceiver 228. As described above, hub 220 may be configured to receive information from electronic module 210 (e.g., a dispense indicator, a time period, a user identifier), and transmit information regarding a dispensing action (e.g., a dispense indicator, a time period, a user identifier, and a location identifier) to network server 230. In some embodiments, hub 220 may also be configured to receive information from network server 230 as described in greater detail below.

Processor 226 may comprise, for example, a microprocessor, microcontroller, digital signal processor (DSP), application specific integrated circuit (ASIC), or any other digital or analog circuitry configured to interpret and/or execute program instructions and/or process data. In some embodiments, processor 226 may interpret and/or execute program instructions and/or process data stored in memory 224. Memory 224 may be configured in part or whole as application memory, system memory, or both. Memory 224 may include any system, device, or apparatus configured to hold and/or house one or more memory modules. Each memory module may include any system, device or apparatus configured to retain program instructions and/or data for a period of time (e.g., computer-readable storage media). Instructions, logic, or data for configuring the operation of hub 220, for example configurations of components such as transceiver 228, may reside in memory 224 for execution by processor 226.

As described above, hub 220 may be configured to receive information regarding a hand dispensing action. Accordingly, some portions of hub 220's transceiver 228 may be configured to receive signals based on any suitable communications protocol under which electronic module 210's transceiver 218 may operate. For example, transceiver 228 may be configured to receive information from electronic module 210 under the Wi-Fi, Bluetooth, ANT, or any other suitable protocol. Moreover, in some embodiments, some portions of hub 220's transceiver 228 may be configured to send information to, and receive information from, network server 230. Transceiver 228 may be configured to communicate with network server 230 according to any suitable wired or wireless communications protocol, e.g., Wi-Fi, Local Area Network (“LAN”), Wireless Local Area Network (“WLAN”), or any suitable cellular telecommunications protocol. Although transceiver 228 may be described above as a single device, transceiver 228 may, in some embodiments, include multiple transceivers. For example, in some embodiments, transceiver 228 may include a first transceiver to communicate with electronic module 210 according to the ANT protocol, and a second transceiver to communicate with network server 230 accordingly to a Wi-Fi network protocol. Moreover, in some embodiments, communication between electronic module 210 and hub 220 may include radio-frequency identification (“RFID”) technology. For example, in some embodiments, hub 220 may include an RFID reader. For such embodiments, each electronic module 210 may include a unique RFID tag. Thus, in some embodiments, hub 220 may simply read the RFID tag of electronic module 210 rather than electronic module 210 actively transmitting a user identifier.

In some embodiments, hub 220 may be powered by a standard wall plug. For example, hub 220 may be plugged directly into a standard 2-prong or 3-prong electrical outlet in a hospital room. In such embodiments, the power consumption requirements for hub 220 may be less stringent than, for example, the power consumption requirements of an embodiment of electronic module 210 that may operate on coin cell batteries. The less stringent power consumption requirements of hub 220 may facilitate the use of a low-power configuration for electronic module 210. For example, as described above, electronic module 210 may be configured to transmit information regarding a dispensing action to the nearest room-specific hub 220. In some embodiments of tracking system 200, every room in a hospital, for example, may include a room-specific hub 220. Because the transmission from electronic module 210 to the nearest room-specific hub 220 may be required to cover only a short distance (e.g., the distance across a room), the transmission from electronic module 210 to hub 220 may be a low power transmission. Because hub 220 may be plugged into a wall, for example, hub 220 may then relay that information to network server 230 over a wireless network (e.g., Wi-Fi), or a wired network (e.g., LAN), without concern over draining battery power. In some embodiments (e.g., embodiments described below with reference to FIG. 4), the hub may be powered by a rechargeable battery. The rechargeable nature of the battery in such embodiments may similarly relieve the hub of at least some of the power consumption limitations that may apply to devices such as embodiments of electronic module 210 that may operate on coin cell batteries.

In some embodiments, a different hub 220 may be placed, for example, in every room within a hospital. Different units of hub 220 may be configured to have a zone within which it may communicate with dispenser 205's electronic module 210. Moreover, different units of hub 220 may be configured such that the zone of a first hub 220 (e.g., in a first hospital room) does not overlap with the zone of a second hub 220 (e.g., in a second hospital room). For example, the power level of transceiver 228 may be adjustable such that the area of hub 220's zone may be adjusted to fit the size of the room in which the unit of hub 220 is installed. For example, the power level of transceiver 228 may be decreased such that the area of hub 220's zone corresponds to the area of a small hospital room. Likewise, the power level of transceiver 228 may be increased such that the area of hub 220's zone corresponds to the area of a large hospital room. Further, in some embodiments, transceiver 228 may be a directional transceiver that may be configured such that hub 220's zone extends in a specific direction from hub 220. For example, hub 220 may be configured to be plugged into an electrical wall socket on one side of a hospital room and have a zone that may extend in an inward direction to the inside of the room.

In some embodiments, each hub 220 may include a unique location identifier that corresponds to the location in which it is placed. For example, in some embodiments, each hub 220 may be pre-programmed with a hub identifier. When different hubs 220 are installed in different rooms of a hospital, for example, the hub identifier may be associated with the location of the room, and thus may serve as a location identifier. For the purposes of the present disclosure, a unique hub identifier that may be capable of serving as a location identifier when associated with a location, may also be referred to as a location identifier. In some embodiments, each hub 220 may include a programmable location identifier. When such embodiments of hub 220 are installed, each hub 220 may be programmed with a unique location identifier that corresponds to the hub's location (e.g., a hospital room).

In some embodiments, the hub identifier and/or location identifier may be stored in memory 224. When hub 220 receives, for example, a user identifier, a time period, and a dispense indicator, processor 226 may read the location identifier from memory 224 and may associate hub 220's location identifier with the received user identifier, time period, and dispense indicator. Hub 220 may then transmit the user identifier, time period, and dispense indicator, along with the location identifier to network server 230. Likewise, when hub 220 receives, for example, a user identifier at the regular programmed interval of electronic module 210, processor 226 may read the location identifier from memory 224 and may associate hub 220's location identifier with the received user identifier. Hub 220 may then transmit the user identifier along with the location identifier to network server 230.

As described above, in some embodiments, hub 220 may include a clock that may track the time of day. Hub 220 may add user-time information to any user identifier periodically received from electronic module 210. Accordingly, hub 220 may transmit the user identifier, the user-time information, and hub 220's location information to network server 230 after each time a user identifier is received from electronic module 210. Likewise, hub 220 may calculate and add dispense-time information to any user identifier that is received with a time period, dispense indicator, and/or time stamp. For example, hub 220 may add dispense-time information after calculating the time of a dispensing action based on the time period, the time stamp of the dispense indicator, and the time at which transmission of this information was received by hub 220. Accordingly, network server 230 may use the dispense-time information calculated by hub 220 to track the time at which the dispensing action occurred.

In some embodiments, information regarding hand hygiene compliance may be communicated to a user via hub 220's display 222. For example, in some embodiments, hub 220 may record dispense indicators and the user identifiers associated with those dispense indicators, and may display such information on display 222. Moreover, hub 220 may receive statistics from network 230 and may display those statistics on display 222. For example, after a user enters a room and hub 220 transmits a user identifier and a location identifier to network server 230, network server 230 may transmit hand hygiene statistics for the identified user back to hub 220. Such statistics may include, for example, a list of times and locations for a user's recent dispensing actions. Moreover, network server 230 may transmit a notification to hub 220 that may be displayed on display 222 to notify a user whether they are in compliance with one or more hand hygiene protocols, e.g., a rule that they must sanitize their hands every time they enter a patient room.

Although some embodiments of hub 220 may be described herein and sending information directly to, or receiving information directly from, network server 230, in some embodiments hub 220 may communicate with network server 230 through any suitable number of intermediary devices. For example, in some embodiments, hub 220 may be configured to communicate with network server though a WLAN network. Accordingly, hub 220 may wirelessly send information to a wireless router that may then route that information to network server 230. Likewise, hub 220 may receive information from network server 230 via a wireless router.

Network server 230 may include a display 232, a memory 234, a processor 236, and a transceiver 238. As described above, network server 230 may be configured to receive information from hub 220 (e.g., a dispense indicator, a user identifier, and a location identifier). In some embodiments, hub 220 may also be configured to transmit information to hub 220.

Processor 236 may comprise, for example, a microprocessor, microcontroller, digital signal processor (DSP), application specific integrated circuit (ASIC), or any other digital or analog circuitry configured to interpret and/or execute program instructions and/or process data. In some embodiments, processor 236 may interpret and/or execute program instructions and/or process data stored in memory 234. Memory 234 may be configured in part or whole as application memory, system memory, or both. Memory 234 may include any system, device, or apparatus configured to hold and/or house one or more memory modules. Each memory module may include any system, device or apparatus configured to retain program instructions and/or data for a period of time (e.g., computer-readable storage media). Instructions, logic, or data for configuring the operation of network server 230, for example configurations of components such as transceiver 238, may reside in memory 234 for execution by processor 236.

Network server 230 may be configured to receive information (e.g., a user identifier, a location identifier, a time period, and a dispense indicator) from different units of hub 220 that may, for example, be located in different rooms of a hospital. Every time a room's hub 220 receives the user identifier, that hub 220 may transmit the user identifier and that hub 220's location identifier to network server 230. Network server 230's processor 236 may then record the user identifier and the location identifier into memory 234. Network server 230 may also determine and record into memory 234 a user time based on the time at which the user identifier and the location identifier were received at network server 230. Each user's electronic module 210 may communicate with different location-specific hubs 220 as the users travel to different rooms within a hospital. Accordingly, network server 230 may collect information regarding the location of different users along a timeline as they travel to and from different rooms within the hospital.

When a user's electronic module 210 senses a dispensing action, that user's electronic module 210 may transmit a time period and dispense indicator including a time stamp with the next periodic transmission of the user identifier. The nearest location-specific hub 220 may receive the user identifier, the time period, and the dispense indicator and may subsequently transmit the user identifier, the time period, the dispense indicator, and that hub 220's location information to network server 230. Processor 236 of network server 230 may record the received data into memory 234. Moreover, network server 230 may determine and record into memory 234 a dispense time based on the time period, the dispense indicator's time stamp, and the time at which the time period and dispense indicator were received at network server 230. Accordingly, network server 230 may collect information regarding when and where different users sanitized their hands.

Network server 230 may combine a user's time and location information with information regarding when and where that user sanitized their hands to generate a number of hand hygiene statistics that may be compared to various hand hygiene protocols. For example, network server 230 may track whether a user sanitized their hands every time they entered a patient room. Likewise, network server 230 may calculate the rate at which a user sanitized their hands over a given period of time, and may track whether that rate meets a required sanitizing frequency, e.g., at least once every thirty minutes. Further, network server 230 may calculate the number of times a user sanitized their hands over a period of time, e.g., a doctor's or a nurse's shift.

Network server 230 may collect and communicate such statistics to display 232. Display 232 may include any display suitable to communicate the collected statistics to one or more hospital employees who may use the information. For example, in some embodiments, display 232 may be a computer monitor in hospital administrator's office. Accordingly, the hospital administrator may view the collected hand hygiene statistics and may monitor the hand hygiene compliance of the hospital's employees. As described above, in some embodiments, network server 230 may also transmit selected statistics and/or compliance notifications back to hub 220 for communication on display 222. For example, after a user enters a room and hub 220 transmits a user identifier and a location identifier to network server 230, network server 230 may transmit hand hygiene statistics for the identified user back to hub 220 for display on display 222.

Although electronic module 210 may be described herein as being configured to operate in conjunction with dispenser 205, in some embodiments, electronic module 210 may be operated independently from dispenser 205. For example, for some embodiments, a user may carry electronic module 210 separately from a dispenser. For such embodiments, the dispenser may be any suitable mobile or stationary dispenser. For example, the dispenser may be implemented by a dispenser installed on the wall of hospital room. Moreover, in some embodiments, sensor 211 may include any suitable sensor configured to sense a dispensing action by any suitable technique. For example, in some embodiments, a dispenser may be mounted on a wall in a hospital room and may be configured transmit a wireless signal each time it dispenses a dose of hand sanitizer. For such embodiments, sensor 211 may be configured to sense the wireless signal from the stationary dispenser and may communicate the sensing of the dispensing action to processor 216. Electronic module 210 may record a dispense indicator and/or time stamp and transmit that information to hub 220 in the same manner as describe above. In some embodiments, sensor 211 may be configured to be independently activated by a user after the user washes or sanitizes their hands. For example, in embodiments that include a contact switch (e.g., contact switch 152 described in reference to FIG. 1), the user may wash and/or sanitize their hands and then push the contact switch, which may in turn trigger sensor 211. For the purposes of the present disclosure, any action by which sensor 211 may be triggered (e.g., by automatically sensing a dispensing action or by receiving a press from a user who has washed or sanitized their hands) may be referred to as electronic module 210 sensing a dispensing action.

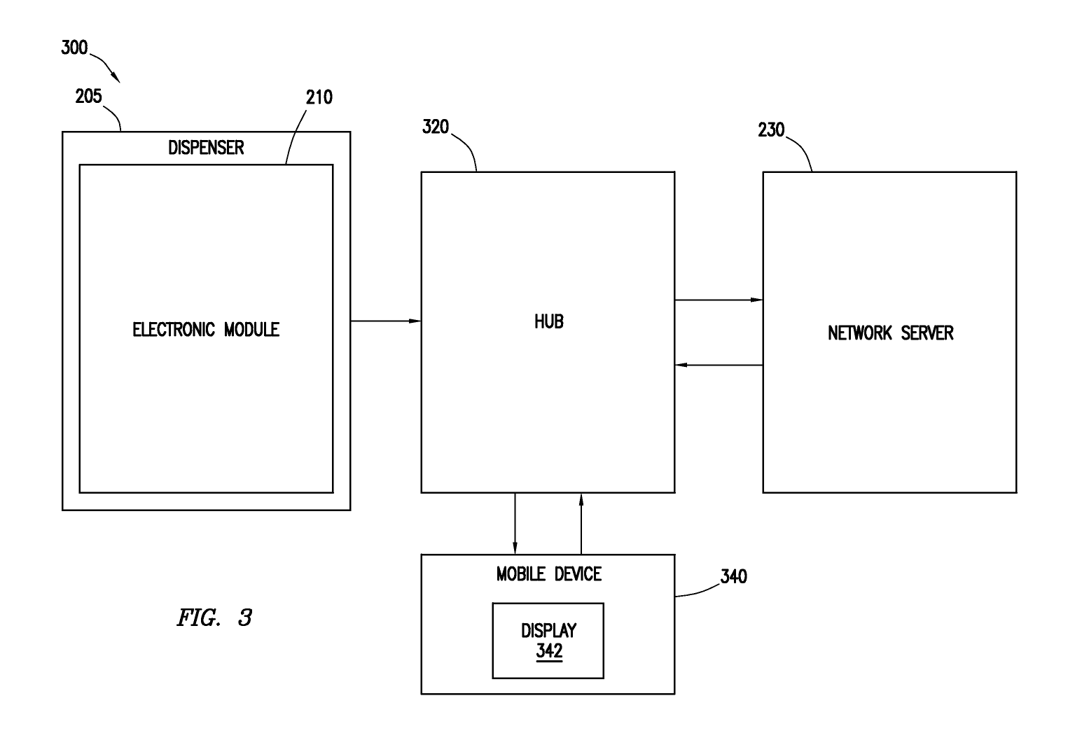

FIG. 3 illustrates a block diagram of a hand hygiene tracking system 300, in accordance with certain embodiments of the present disclosure. Tracking system 300 may include a hub 320 and a mobile device 340. In some embodiments, hub 320 may include similar components (e.g., a processor, a memory, a clock, a display, and a transceiver) as some embodiments of hub 220 described above with reference to FIG. 2B, and may be configured to communicate with mobile device 340 in order to display information on mobile device 340's display 342. Mobile device 340 may be any suitable device with a display screen that may carried by a user as the user travels to different locations within, for example, a hospital. For example, in some embodiments, mobile device 340 may be a user's tablet computer or a user's smart phone. Hub 320 may communicate with mobile device 340 over any suitable communication protocol. For example, hub 320 may be configured to communicate with mobile device 340 over a Bluetooth and/or a Wi-Fi connection. In some embodiments, when a user enters a room, that user's mobile device 340 (as well as their electronic module 210) may establish a wireless communication with that room's location-specific hub 320. Rather than displaying hand hygiene statistics on a display that may be located directly on hub 320, hub 320 may communicate any hand hygiene statistics that hub 320 has collected and/or has received from network server 230 to mobile device 340. Mobile device 340 may be configured to then communicate those statistics to a user via display 342.

In some embodiments, mobile device 340 may receive information to be displayed on display 342 from devices other than hub 320. For example, in some embodiments, network server 230 may send hand hygiene statistics for a user directly to that user's mobile device 340 for display on display 342. Network server 230 may communicate with mobile device over any suitable communication protocol. For example, network server may be configured to communicate with mobile device 340 a Wi-Fi and/or a cellular network connection.

FIG. 4 illustrates a block diagram of a hand hygiene tracking system 400, in accordance with certain embodiments of the present disclosure. Tracking system 400 may include a mobile hub 420 and a location transmitter 440. In some embodiments, mobile hub 420 may include similar components (e.g., a processor, a memory, a display, and a transceiver) as some embodiments of hub 220 described above with reference to FIG. 2B, and may also be configured to move with a user as the user travels to different locations within, for example, a hospital.

Mobile hub 420 may be configured to receive information from electronic module 210 over any suitable communication protocol, including but not limited to, Wi-Fi, Bluetooth, ANT, or any other suitable protocol. Moreover, mobile hub 420 may be configured to send information to, and receive information from, network server 230 over any suitable communication protocol, including but not limited to Wi-Fi, WLAN, or a cellular telecommunication network.

In some embodiments, mobile hub 420 may be, for example, a user's tablet computer or a user's smart phone. In such embodiments, mobile hub 420 may include a rechargeable battery. As described above, mobile hub 420 may receive information from electronic module 210 over a micro-power communication protocol such as the ANT protocol. Utilizing a micro-power communication protocol such as the ANT protocol may allow electronic module 210 to conserve energy while being powered by coin cell batteries. The rechargeable nature of mobile hub 420 may then allow mobile hub 420 to transmit hand hygiene information to network server 230 under less stringent power consumption constraints.

Because mobile hub 420 may be a mobile device without a predefined location or a predefined location identifier, mobile hub 420 may be configured to receive location information from another device. In some embodiments, mobile hub 420 may be configured to receive location information from location transmitter 440 and to temporarily store that location information into a memory until mobile hub 420 moves into communication with another location transmitter 440. For example, each patient room in a hospital may be equipped with a unit of location transmitter 440 that may include a unique location identifier. Each location transmitter 440 may transmit, over any suitable communication protocol, a unique room-specific location identifier to any mobile hub 420 that enters the patient room. Accordingly, mobile hub 420 may associate the received location identifier to any user identifier and/or dispense information received from electronic module 210. For example, when mobile hub 420 receives a user identifier from electronic module 210 at a regular interval, mobile hub 420 may transmit that user identifier and the location identifier received from location transmitter 440 to network server 230. Likewise, when mobile hub 420 receives a user identifier and dispense information (e.g., a time period and a dispense indicator including a time stamp), mobile hub 420 may transmit the user identifier and the dispense information with the location identifier received from location transmitter 440 to network server 230.

In some embodiments, location transmitter 440 may transmit location information directly to electronic module 210. For such embodiments, electronic module 210 may transmit a location identifier received from location transmitter 440 to mobile hub 420 along with any transmissions of a user identifier and/or dispense information that electronic module 210 may transmit to mobile hub 420. Mobile hub 420 may then temporarily store that location identifier into a location identification memory located in mobile hub 420 prior to sending the location identifier along with any user identifier and/or dispense information to network server 230.

Although location transmitter 440 may be described above as a transmitter, location transmitter 440 may be a passive device such as an RFID tag. For such embodiments, mobile hub 420 and/or electronic module 210 may include an RFID reader that may read a location-specific RFID tag. For example, as mobile hub 420 enters a hospital patient room equipped with a location specific RFID tag, mobile hub 420 may read the location-specific RFID tag and temporarily store a location identifier to a memory and transmit a corresponding location identifier along with any transmissions of the user identifier.

As described above, in some embodiments, mobile hub 420 may be a device such as a user's smartphone or tablet computer. Accordingly, in some embodiments, mobile hub 420 may be a user-specific device. For such embodiments, mobile hub 420 may provide the user identifier and thus may relieve electronic module 210 of the task of sending a user identifier to mobile hub 420 at a regular interval. For example, mobile hub 420 may send a user identifier stored in mobile hub 420 along with a location identifier to network server 230 at a regular interval in order for tracking system 400 to track the location of a user along a timeline. When a dispensing action occurs, electronic module 210 may send a dispense indicator to mobile hub 420. Mobile hub 420 may then calculate and send the dispense-time information along with the user identifier, the transmission time information, and the location identifier to network server 230. Accordingly, tracking system 400 may also track the times and locations at which a user sanitized their hands in order to determine if the user complied with hand hygiene protocols. Allocating the transmission of the user identifier at the regular interval to the mobile hub 420 may further reduce the power consumption of electronic module 210.

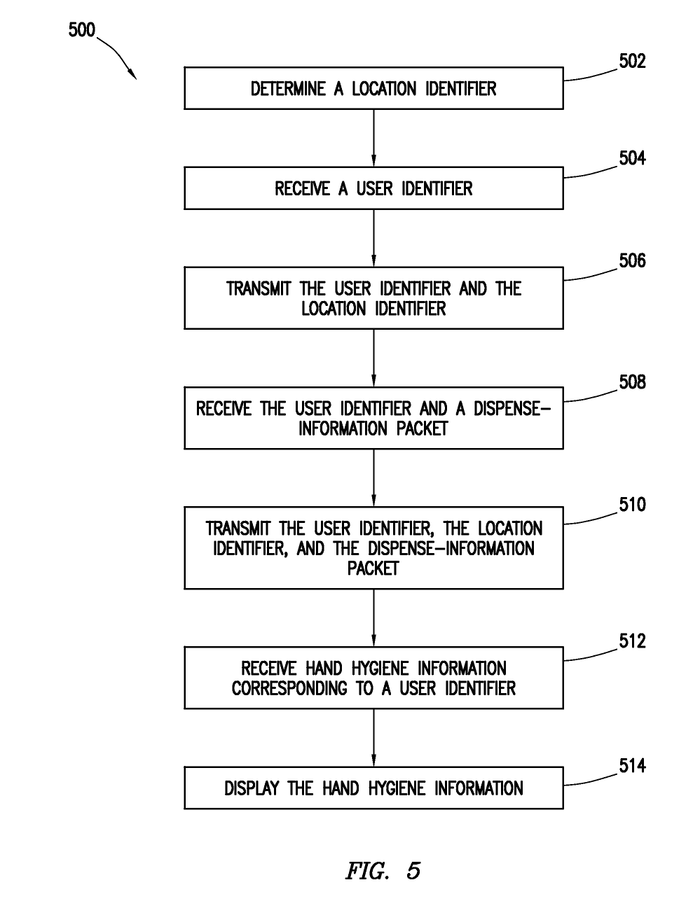

FIG. 5 illustrates a flow chart depicting method 500 for communicating hand hygiene information, in accordance with certain embodiments of the present disclosure.

At step 502, a location identifier may be determined. For example, in some embodiments, processor 226 may read a location identifier stored in a portion of memory 224 in hub 220.

At step 504, a user identifier may be received from an electronic module at a first time. For example, hub 220 may receive a first periodic transmission of the user identifier from electronic module 210.

At step 506, the user identifier and the location identifier may be transmitted to a network server after receiving the user identifier from the electronic module at the first time. For example, hub 220 may transmit the user identifier and the location identifier to network server 230 after receiving the user identifier form electronic module 210 in step 504.

At step 508, the user identifier and a dispense-information packet may be received from the electronic module at a second time. In some embodiments, the dispense-information packet may include a time period and a dispense indicator including a time stamp. Hub 220 may receive the time period and the dispense indicator along with a second periodic transmission of the user identifier from electronic module 210.

At step 510, the user identifier, the location identifier, and the dispense information packet may be transmitted to the network server after user identifier and the dispense-information packet was received from the electronic module at the second time. For example, hub 220 may transmit the user identifier, the location identifier, and the dispense-information packet to network server after receiving the user identifier and dispense-information packet from electronic module 210 at step 508.

At step 512, hand hygiene information corresponding to the user identifier may be received from the network server. For example, after hub 220 sends a user identifier to network server 230, network server 230 may send hand hygiene statistics corresponding to that user identifier back to hub 220. Those statistics may include information that network server 230 received from other hubs in other locations. Moreover, the statistics may include information such as how often a user identified by the user identifier has sanitized their hands over a period of time.

At step 514, hand hygiene information may be displayed. For example, in some embodiments, hub 220 may display statistics received from network server 230 at step 512 on display 222.

Although FIG. 5 discloses a particular number of steps to be taken with respect to method 500, method 500 may be executed with greater or lesser steps than those depicted in FIG. 5. For example, method 500 may be performed without steps 512 and 514. In addition, although FIG. 5 discloses a certain order of steps to be taken with respect to method 500, the steps comprising method 500 may be performed in any suitable order. For example, in some embodiments, steps 512 and 514 may be performed directly after step 506.

Method 500 may be implemented using the tracking system of FIGS. 2A-4, or any other system operable to implement method 500. In some embodiments, some elements may be optionally omitted, repeated, or combined. In certain embodiments, method 500 may be implemented partially or fully in software embodied in computer-readable media.

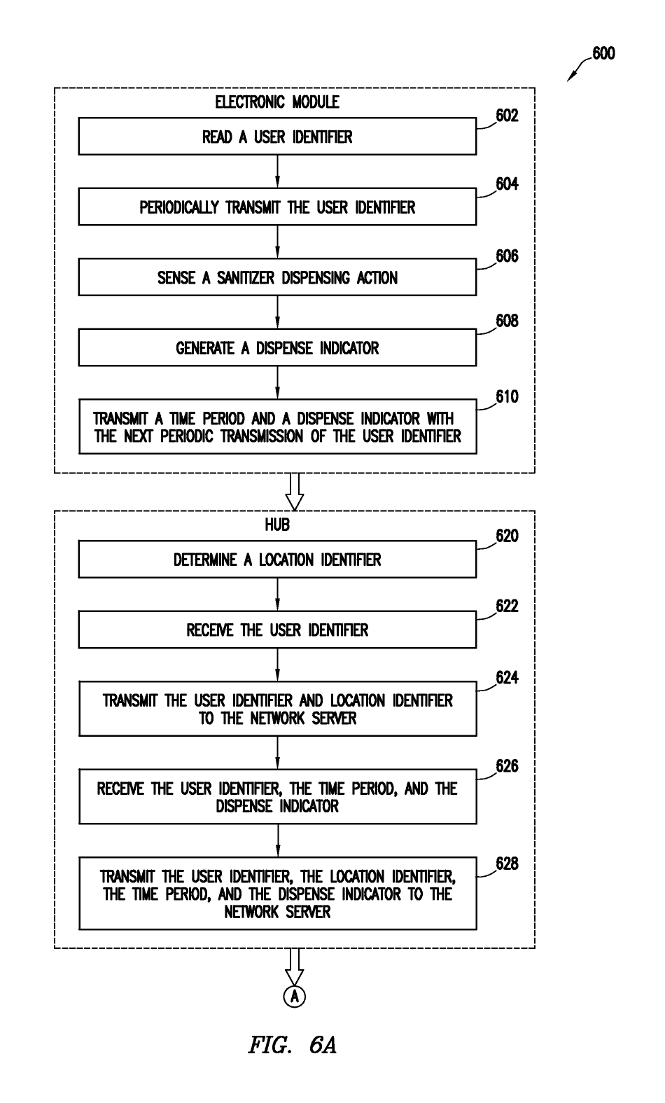

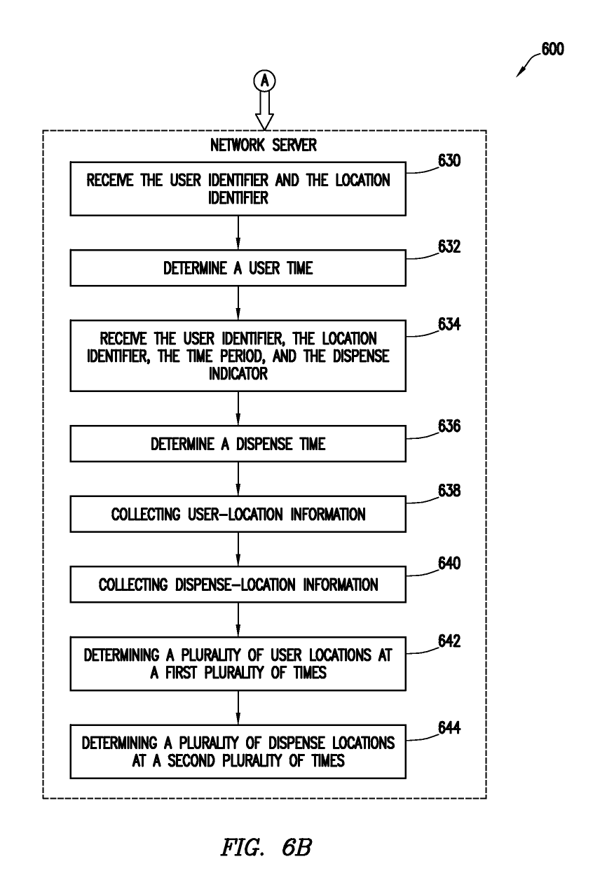

FIGS. 6A and 6B illustrate a flow chart depicting method 600 for communicating hand hygiene information, in accordance with certain embodiments of the present disclosure. In general, information may flow from an electronic module to a hub, and then from the hub to the network server.

Step 602 through step 610 may represent steps that may occur at the electronic module.

At step 602, a user identifier may be read from a user identifier memory. For example, in some embodiments, electronic module 210 may read the user identifier from user identifier memory 212.

At step 604, the user identifier may be periodically transmitted to a network at an interval of time. For example, transceiver 218 of electronic module 210 may periodically transmit the user identifier to a network hub 220 at an interval of time. In some embodiments, the interval of time may range from approximately one second to approximately sixty seconds. In some embodiments, the interval of time may range from approximately five seconds to approximately twenty-five seconds.

At step 606, a sanitizer dispensing action may be sensed. For example, sensor 211 may sense that dispenser 205 dispensed a dose hand sanitizer.

At step 608, a dispense indicator may be generated. For example, in some embodiments, sensor 211 may communicate the sensing of the dispensing action from step 606, and processor 216 may generate a dispense indicator and/or record the dispense indicator to memory 214. In some embodiments, electronic module 210 may include a timer that may count the time between successful periodic transmissions of the user identifier. In such embodiments, the dispense indicator may include a time stamp that may reflect the amount of time between the previous successful periodic transmission of the user identifier to the sensing of the sanitizer dispensing action.

At step 610, a time period and the dispense indicator may be transmitted with the next periodic transmission of the user identifier after the sensing of the dispensing action.

Step 620 through step 628 may represent steps that may occur at a network hub.

At step 620, a location identifier may be determined. For example, in some embodiments, hub 220 may read the location identifier from a location identifier memory located in hub 220. In some embodiments, the location identifier memory may be included within memory 224.

At step 622, the user identifier may be received at a network hub from an electronic module at a first time. For example, in some embodiments, hub 220 may receive a first periodic transmission of the user identifier from electronic module 210 at a first time.

At step 624, the user identifier and the location identifier may be transmitted, from the network hub to the network server after the user identifier was received at the network hub at the first time. For example, hub 220 may transmit the user identifier and the location identifier to network server 230 after hub 220 received the user identifier at the first time in step 622.

At step 626, the user identifier, a time period, and a dispense indicator may be received at the network hub from the electronic module at a second time. For example, hub 220 may receive the time period and the dispense indicator along with a second periodic transmission of the user identifier from electronic module 210 at a second time.

At step 628, the user identifier, the location identifier, the time period, and the dispense indicator may be transmitted from the network hub to the network server after the user identifier, the time period, and the dispense indicator were received at the network hub at the second time. For example, hub 220 may transmit the user identifier, the location identifier, the time period, and the dispense indicator to network server 230 after receiving the user identifier, the time period, and the dispense indicator from electronic module 210 at the second time in step 626.

Step 630 through step 644 may represent steps that may occur at the network server.

At step 630, the user identifier and the location identifier may be received at a first time. For example, network server 230 may receive the user identifier and the location identifier transmitted from hub 220 at step 624.

At step 632, a user time may be determined based on the first time. For example, network server 230 may calculate a user time based on the first time, e.g., the time at which the user identifier was received by network server 230 in step 630.

At step 634, the user identifier, the location identifier, the time period, and the dispense indicator may be received at network server at a second time. For example, network server 230 may receive the user identifier, the location information, the time period, and the dispense indicator transmitted from hub 220 at step 628.

At step 636, a sanitizer dispense time may be determined based on the time period, the dispense indicator, and the second time. For example, network server 230 may calculate the dispense time based on the time period and a time stamp included in the dispense indicator received at step 634, as well as the second time, e.g., the time at which the information was received at step 634.

Steps 602 through 636 may be repeated any suitable number of times. Accordingly, multiple instances of time and location information for a user may be received by network server 230 as well as time and location information for multiple dispensing actions associated with a specific user identifier.

At step 638, at least one instance of user-location information may be collected. For example, network server 230 may collect multiple instances of a hospital employee's user-location information over a period of time, e.g., over that employee's work shift. In some embodiments, network server 230 may receive, from a plurality of location-specific hubs 220, one or more instances of that employee's user identifier as well as corresponding location identifiers. Network server 230 may also calculate corresponding user times based on the times at which the instances of the user identifier were received.

At step 640, at least one instance of dispense-location information may be collected. For example, network server 230 may collect multiple instances of a hospital employee's dispense-location information over a period of time, e.g., over that employee's work shift. In some embodiments, network server 230 may receive, from a plurality of location-specific hubs 220, one or more instances of that employee's user identifier as well as corresponding location identifiers and corresponding dispense indicators. Network server 230 may also calculate corresponding dispense times based on the times at which the dispense indicators were received and timing information included in and/or accompanying each dispense indicator.

At step 642, a plurality of user locations may be determined for a first plurality of times. For example, network server 230 may determine where a user (e.g., a hospital employee) was located at a plurality of times throughout that user's work shift based on the location identifiers and the user times associated with the employee's user identifier.

At step 644, a plurality of dispense locations may be determined for a second plurality of times. For example, network server 230 may determine when and where a user sanitized their hands based on the location identifiers and a plurality of sanitizer dispense times associated with the employee's user identifier.

Although FIGS. 6A and 6B disclose a particular number of steps to be taken with respect to method 600, method 600 may be executed with greater or lesser steps than those depicted in FIGS. 6A and 6B. For example, method 600 may be performed without step 642. In addition, although FIGS. 6A and 6B disclose a certain order of steps to be taken with respect to method 600, the steps comprising method 600 may be performed in any suitable order. For example, in some embodiments, steps 624 and 630 may be performed simultaneously.

Method 600 may be implemented using the tracking system of FIGS. 2A-4, or any other system operable to implement method 600. In some embodiments, some elements may be optionally omitted, repeated, or combined. In certain embodiments, method 600 may be implemented partially or fully in software embodied in computer-readable media.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, and other electromagnetic and/or optical carriers; and/or any combination of the foregoing. The following examples pertain to further embodiments. Specifics in the examples may be used anywhere in one or more embodiments described above or herein.

Although the present disclosure has been described in detail, it should be understood that various changes, substitutions, and alterations can be made hereto without departing from the spirit and the scope of the disclosure as defined by the appended claims.

What is claimed is:

1. A method, comprising:
collecting at a network server at least one instance of user-location information, wherein each instance of the user-location information includes a user identifier, a location identifier, and a user time; and
collecting at a network server at least one instance of dispense-location information, wherein each instance of the dispense-location information includes the user identifier, the location identifier, and a sanitizer dispense time.

2. The method of claim 1, further comprising:
determining a plurality of user locations at a first plurality of times based on a first plurality of location identifiers and a plurality of user times associated with the user identifier; and
determining a plurality of dispense locations at a second plurality of times based on a second plurality of location identifiers and a plurality of sanitizer dispense times associated with the user identifier.

3. The method of claim 1, further comprising:
receiving at the network server the user identifier and the location identifier at a first time;
determining the user time based on the first time;
receiving at the network server the user identifier, the location identifier, a time period, and a dispense indicator at a second time; and
determining the sanitizer dispense time based on the time period, the dispense indicator, and the second time.

4. The method of claim 3, wherein:
the time period comprises a first time difference between a first periodic transmission from an electronic module including the user identifier and a second periodic transmission from the electronic module including the user identifier and the dispense indicator; and
wherein the dispense indicator comprises a time stamp including a second time difference between the first periodic transmission and a sensing of a sanitizer dispensing action.

5. The method of claim 1, further comprising:
reading the user identifier from a user identifier memory;
periodically transmitting the user identifier to a network at an interval of time;
sensing a sanitizer dispensing action;
generating a dispense indicator; and
transmitting a time period and the dispense indicator with the next periodic transmission of the user identifier after sensing the dispensing action.

6. The method of claim 5, wherein the interval is a time from approximately one second to approximately sixty seconds.

7. The method of claim 1, further comprising:
determining the location identifier;
receiving at a network hub the user identifier from an electronic module at a first time;
transmitting, from the network hub to the network server, the user identifier and the location identifier after receiving the user identifier at the network hub at the first time;
receiving at the network hub the user identifier, a time period, and a dispense indicator from the electronic module at a second time; and
transmitting, from the network hub to the network server, the user identifier, the location identifier, the time period, and the dispense indicator to the network server after receiving the user identifier, the time period, and the dispense indicator at the network hub at the second time.

8. The method of claim 7, wherein determining the location identifier comprises reading the location identifier from a location identifier memory.

9. A hygiene tracking system, comprising:
a network server configured to:
collect at least one instance of user-location information, wherein each instance of the user-location information includes a user identifier, a location identifier, and a user time; and
collect at least one instance of dispense-location information, wherein each instance of the dispense-location information includes the user identifier, the location identifier, and a dispense time.

10. The hygiene tracking system of claim 9, wherein the network server is further configured to:
determine a plurality of user locations at a first plurality of times based on a first plurality of location identifiers and a plurality of user times associated with the user identifier; and
determine a plurality of dispense locations at a second plurality of times based on a second plurality of location identifiers and a plurality of sanitizer dispense times associated with the user identifier.

11. The hygiene tracking system of claim 9, wherein the network server is further configured to:
receive the user identifier and the location identifier at a first time;
determine the user time based on the first time;
receive the user identifier, the location information, a time period, and a dispense indicator at a second time; and
determine the sanitizer dispense time based on the time period, the dispense indicator, and the second time.

12. The hygiene tracking system of claim 11, wherein:
the time period comprises a first time difference between a first periodic transmission from an electronic module including the user identifier and a second periodic transmission from the electronic module including the user identifier and the dispense indicator;
wherein the dispense indicator comprises a time stamp including a second time difference between the first periodic transmission and a sensing of a sanitizer dispensing action.

13. The hygiene tracking system of claim 9, further comprising an electronic module configured to:
read the user identifier from a user identifier memory;
periodically transmit the user identifier to a network hub at an interval of time;
sense a sanitizer dispensing action;
generate a dispense indicator; and
transmit a time period and the dispense indicator with the next periodic transmission of the user identifier after sensing the sanitizer dispensing action.

14. The hygiene tracking system of claim 11, wherein the interval is a time from approximately one second to approximately sixty seconds.

15. The hygiene tracking system of claim 8, further comprising a network hub configured to:
determine the location identifier;
receive the user identifier from an electronic module at a first time;
transmit the user identifier and the location identifier to the network server after receiving the user identifier at the first time;
receive the user identifier, a time period, and a dispense indicator from the electronic module at a second time;
transmit the user identifier, the location identifier, the time period, and the dispense indicator to the network server after receiving the user identifier and the dispense indicator at the second time.

16. The hygiene tracking system of claim 13, wherein the network hub is configured to read the location identifier from a location identification memory located in the network hub.

17. A hygiene tracking hub, comprising:
a location identification memory configured to store a location identifier; and
a transceiver configured to:
receive the user identifier from an electronic module at a first time;
transmit the user identifier and the location identifier to a network server after receiving the user identifier from the electronic module at the first time;
receive the user identifier and a dispense-information packet from the electronic module at a second time;
transmit the user identifier, the location identifier, and the dispense-information packet to the network server after receiving the user identifier and the dispense-information packet from the electronic module at the second time.

18. The hygiene tracking hub of claim 17, wherein:
the dispense-information packet includes a time period and a dispense indicator comprising a time stamp;
the time period comprises a first time difference between the first time and the second time; and
the time stamp comprises a second time difference between the first time and a sensing of a sanitizer dispensing action.

19. The hygiene tracking hub of claim 17, wherein the transceiver is further configured to:
communicate with the electronic module according to a first communication protocol; and
communicate with the network server according to a second communication protocol, wherein the first communication protocol and the second communication protocol are different.

20. The hygiene tracking hub of claim 17, wherein the transceiver includes an adjustable range within which the transceiver may communicate with the electronic module.

21. The hygiene tracking hub of claim 17, wherein:
the transceiver is configured to receive hygiene information, corresponding to the user identifier, from the network server; and
the hygiene tracking hub further comprises a display configured to display the hygiene information.

22. The hygiene tracking hub of claim 17, wherein:
the hygiene tracking hub is configured to be installed in a stationary location; and
the location identifier corresponds to the stationary location.

23. The hygiene tracking hub of claim 17, wherein the hygiene tracking hub is configured to:
receive the location identifier from a location transmitter; and
write the location identifier to the location memory.

24. A method, comprising:
determining a location identifier;
receiving the user identifier from an electronic module at a first time;
transmitting the user identifier and the location identifier to a network server after receiving the user identifier from the electronic module at the first time;
receiving the user identifier and a dispense-information packet from the electronic module at a second time; and
transmitting the user identifier, the location identifier, and the dispense-information packet to the network server after receiving the user identifier and the dispense-information packet from the electronic module at the second time.

25. The method of claim 24, wherein:
the dispense-information packet includes a time period and a dispense indicator comprising a time stamp;
the time period comprises a first time difference between the first time and the second time; and
the time stamp comprises a second time difference between the first time and a sensing of a sanitizer dispensing action.

26. The method of claim 24, wherein determining the location identifier comprises reading the location identifier from a location identifier memory.

27. The method of claim 24, further comprising:
communicating with the sanitizer dispenser according to a first communication protocol; and
communicating with the network server according to a second communication protocol.

28. The method of claim 24, further comprising adjusting the distance from which the hub may communicate with the sanitizer dispenser.

29. The method of claim 24, further comprising:
receiving hygiene information corresponding to the user identifier from the network server; and
displaying the hygiene information.

30. The method of claim 24, further comprising:
receiving the location identifier from a location transmitter; and
writing the location identifier to the location memory.
